(19) United States
(12) Patent Application Publication
(10) Pub. No.: US 2014/0368655 A1
(43) Pub. Date: Dec. 18, 2014

(54) METHOD FOR OPERATING A DRIVER ASSIST SYSTEM FOR MANEUVERING AND/OR PARKING A MOTOR VEHICLE

(71) Applicant: AUDI AG, Ingolstadt (DE)

(72) Inventors: Michael Schlittenbauer, Ingolstadt (DE); Martin Roehder, Ingolstadt (DE); Yosef Dalbah, Ingolstadt (DE)

(21) Appl. No.: 14/304,142

(22) Filed: Jun. 13, 2014

(30) Foreign Application Priority Data
Jun. 14, 2013 (DE) 10 2013 010 010.0

(51) Int. Cl. B60R 11/04; G06T 17/00

(52) U.S. Cl. CPC B60R 11/04; G06T 17/00
USPC 348/148

(57) ABSTRACT

A method for operating a driver assist system for supporting a driver during maneuvering and/or parking a motor vehicle includes recording with at least one environmental sensor three-dimensional environmental data of an environment of the motor vehicle; generating with the driver assist system a three-dimensional model based on the three-dimensional data recorded by the environmental sensor, said model describing at least a portion of the motor vehicle and at least a portion of the environment of the motor vehicle; generating with the driver assist system at least one image using the three-dimensional model, said image showing at least the at least one portion of the motor vehicle in relation to surrounding objects; and displaying the image on a display.

### CROSS-REFERENCES TO RELATED APPLICATIONS

This application claims the priority of German Patent Application, Serial No. 10 2013 010 010.0, filed Jun. 14, 2013, pursuant to 35 U.S.C. 119(a)-(d), the disclosure of which is incorporated herein by reference.

### BACKGROUND OF THE INVENTION

The present invention relates to a method for operating a driver assist system for supporting a driver during maneuvering and/or parking a motor vehicle

The following discussion of related art is provided to assist the reader in understanding the advantages of the invention, and is not to be construed as an admission that this related art is prior art to this invention.

Driver assist systems for motor vehicles which support the driver during parking and/or maneuvering are known from the state-of-the-art and are referred to for example as parking assist systems. Such driver assist systems usually operate with ultrasound sensors as environmental sensors, which roughly measure the environment, and more particularly distances to objects. These sensor data of the ultrasound sensors are converted by an appropriate calculation device into an image for example a top view onto the motor vehicle, which shows where in the vicinity of the motor vehicle and at what distances an obstacle is located. In particular bar diagrams are frequently used in which different distance ranges in a sector of the environment of the motor vehicle are symbolized by bars which can for example be filled and/or highlighted, for example colored red, when the ultrasound sensor has detected an object within this distance range.

However, such parking assist systems do not provide a detailed image of the environment for a driver of the motor vehicle. In particular, for example objects under or over which the vehicle may be able to drive are often also detected by ultrasound sensors. These objects cannot be correctly judged by using conventional driver assist systems.

It would therefore be desirable and advantageous to provide a method for operating a driver assist system, which provides more information relating to the environment available for the driver and thus enables an improved maneuvering and/or parking in the presence, of objects.

### SUMMARY OF THE INVENTION

According to one aspect of the present invention, a method for operating a driver assist system for supporting a driver during maneuvering and/or parking a motor vehicle includes recording with at least one environmental sensor three-dimensional environmental data of an environment of the motor vehicle; generating with the driver assist system a three-dimensional model based on the three-dimensional data recorded by the environmental sensor, wherein the model describes at least a portion of the motor vehicle and at least a portion of the environment of the motor vehicle; generating with the driver assist system at least one image using the three-dimensional model, said image showing at least the at least one portion of the motor vehicle in relation to surrounding objects; and displaying the image on a display.

The idea of the present invention is thus to use environmental sensors which record the environment in sensor data which describe the environment in three spatial dimensions as three-dimensional sensor data. This means environmental sensors of the present invention measure the environment three-dimensionally. Since the properties in particular the outer shape of the motor vehicle are known this makes it possible to determine a three-dimensional environmental model which offers an improved basis for generating the image. Using appropriate environmental sensors thus makes it possible to generate a three-dimensional environmental model with an accuracy in the centimeter range which has the advantage that almost any perspective, i.e., any direction of view, can be used for the image. According to the invention it is preferred that the image is determined from the environmental model by rendering. For this, a so-called viewpoint is usually defined together with the direction of view, so that the objects and the motor vehicle can be transformed from the three-dimensional model into a two-dimensional image.

By using environmental sensors which provide sensor data which describe the environment in three spatial dimensions, a highly accurate imaging of the immediate environment of the motor vehicle in the three-dimensional environmental model is possible which forms the basis for a multitude of possible images which, as will be discussed in more detail below, can in particular be adjusted depending on the situation. The driver is thus provided with more information and with this is able to better maneuver the vehicle and/or is better supported during parking close to potential objects, for example a construction.

According to another advantageous feature of the invention, an optical image-providing sensor is used as an environmental sensor, in particular a PMD sensor. PMD sensors (photonic mixing device) or more generally time of flight cameras (TOF-cameras) which are based on PMD sensors, are image providing optical sensors whose functional principle is based on the light travel time method. The measuring objects are illuminated with light impulses and the signal travel time is measured from which the distance between the environmental censor and the object can be calculated. Additionally PMD sensors also provide an optical image of the environment, i.e., they also assign each pixel information regarding the distance. This offers an excellent basis for determining the three-dimensional environmental model.

According to another advantageous feature of the invention, four wide-angle environmental sensors are respectively assigned to one of each side of the motor vehicle. Particularly preferably, wide-angle PMD-sensors or TOF-cameras are thus used one of which covers one of the four sides of the motor vehicle. For example the detection range of such wide-angle environmental sensor can have an opening angle of>160, preferably>170. Such cameras can for example be arranged at the front of the vehicle or centered at the rear of the vehicle; for the sides of the motor vehicle an arrangement at or close to the outer rear mirrors is useful.

According to another advantageous feature of the invention, a portion of the environment of the motor vehicle and/or a direction of view onto the portion, which is described by the environmental model can be selected with regard to a risk of damage for the motor vehicle. In this case the sensor data are thus not only analyzed with regard to generating a three-dimensional environmental model but also with regard to the location of a risk of damage to the motor vehicle. In dependence on this further assessment, the three dimensional environmental model makes it possible to adjust the image in the shown portion of the environment and the direction of view so that the driver can optimally judge the actual critical situation.

Generally speaking a collision risk can thus be determined for the objects contained in the environmental model by taking the ego-data, which describe the actual operating condition of the motor vehicle, into account, and the collision risk be used for the assessment. Concepts for determining the risk of collision, mostly described by a likelihood of collision, are known in the state of the art and for example provide for selecting the portion of the environment of the motor vehicle which is shown in the image so that always the object which has the highest risk of collision, i.e., the highest likelihood of collision, is observed. The image is therefore preferably always generated at least for the portion that currently represents the highest risk of damage.

In a concrete embodiment which can also be easily and advantageously realized, it can be provided that at least a shortest distance of the motor vehicle to an object in the three dimensional model and/or at least the current direction of movement of the motor vehicle are analyzed for the assessment. The direction of movement and the shortest distance thus provide easily determinable yet useful criteria, which can at least clearly define the portion to be displayed. When the object which has the shortest distance and the site or the region of this shortest distance is known, an optimal direction of view also results in most cases to provide the most information for the driver, which will be discussed in more detail in the following.

Because as already mentioned, the use of a three-dimensional environmental model which is based on the three-dimensional sensor data advantageously allows using a broad range of perspectives to generate the imager, in particular to render the image. It has proven particularly useful when the direction of view of the image onto the portion of the environment of the motor vehicle shown in the image extends along a line, which lies in a center plane, preferably a vertical plane, which is defined in a region of shortest distance to an object. This results in an essentially perpendicular a view onto the distance, which correspondingly enables a good assessment of the still available space for maneuvering. Particularly advantageously this is a horizontal line, i.e., the direction of view can be selected so as to lie within a range of +/−20° about the horizontal, in particular to be completely horizontal. In this way the driver can also clearly recognize the lateral profile of the motor vehicle so that for example a driving over or driving underneath an object can be assessed particularly well.

When this selection of directions of view is combined with the concrete assessment of the current situation of the motor vehicle, the possibilities of the three-dimensional environmental model are used ideally. This means that the method according to the invention enables as is known to date to principally realize a view from the top onto the motor vehicle (Top view), depending on the situation, however, the method can also highlight certain aspects in defined directions of view, as the case may be also in an additional image. For example when the driver currently drives toward a curb it is very interesting to obtain a side view, in particular by using a horizontal direction of view, in order to be able to simultaneously assess the distance of the curb to the motor vehicle and the height of the curb. By way of the environment of the motor vehicle described by the three-dimensional environmental model and the operating condition of the motor vehicle described by the ego-data it is thus possible to determine the currently best perspective for the driver in the three-dimensional space and to automatically change the perspective. This makes it possible to realize in a manner of speaking a competent parking guide, which constantly positions himself so as to have the currently critical point in view. For the viewpoint in case of a side view to be rendered, in particular its height, the height can be selected at which in horizontal direction the shortest distance to the object in the shown portion is present or also the eye-level of an imagined observer, for example the guide.

As mentioned before, it can be very useful in the method according to the invention to generate more than one image. For example an overview image can be realized for example a top view onto the motor vehicle, which shows objects in the vicinity of the motor vehicle that have been detected by the environmental sensors with a highest possible positional accuracy. A second image can be an image which is constantly updated based on an assessment of the current situation, which advantageously includes side views, i.e., views with essentially horizontal direction of view which show the portion with the currently highest risk of damage for the motor vehicle in a detail image for the driver in an intuitive and easy to perceive manner.

According to another aspect of the invention, a motor vehicle includes a driver assist system for supporting a driver during maneuvering and/or parking the motor vehicle, including at least one environmental sensor which records three-dimensional sensor data, a display device and a control device which is configured for carrying out the method according to the invention. All embodiments relating to the method according to the invention are also analogously applicable to the motor vehicle according to the invention with which the advantages of the present invention can thus also be obtained. It is particularly preferred when the environmental sensors are configured as wide-angle PMD sensors.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of a motor vehicle according to the invention;

FIG: 2 shows a possible overview image; and

FIG. 3 shows a possible side view of a particularly relevant portion of the environment of the motor vehicle.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

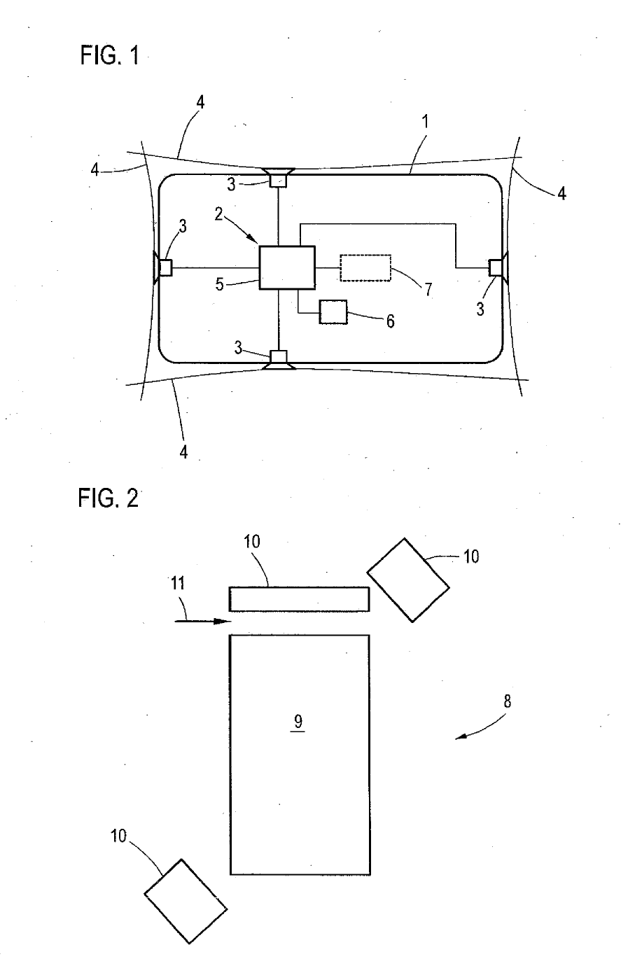

Turning now to the drawing, and in particular to FIG. 1, there is shown a schematic diagram in the form of components of a motor vehicle 1 according to the invention which are relevant for the invention. The motor vehicle includes a driver assist system 2, which supports the driver during moving a parking. For this the motor vehicle 1 further has four environmental sensors 3 which are assigned to the driver assist system 2. These measure the environment of the motor vehicle 1 three-dimensionally, i.e., they provide sensor data which describe the environment of the motor vehicle 1 three-dimensionally. In the present case, these are PMD-sensors, which means the environmental sensors 3 are optical image providing environmental sensors 3, which for each pixel also contain the distance information, which was obtained according to the travel time method. Since the environmental sensors 3 also include an optic which allows covering of a very wide angle, as indicated by the detection ranges 4, it is sufficient to arrange one environmental sensor 3 at one of each side of the motor vehicle 1, in order to be able to detect the relevant portion of the environment of the motor vehicle 1.

The three-dimensional sensor data of the environmental sensors 3 are provided to the control device 5 of the driver assist system 2, where they are processed in order to determine a three-dimensional environmental model of the environment of the motor vehicle 1. The three-dimensional model in turn is used to generate an image which supports the driver during parking and maneuvering, which image can be displayed on a corresponding display device 6. The control device 5 is thus configured for carrying out the method according to the invention. The determination of the image can occur by rendering.

For at least one generated image of the driver assist system 2, here an image which is constantly kept up to date, an assessment of the overall situation of the motor vehicle 1 is used for generating the image, for which the control device 5 is connected with further here only schematically indicated vehicle systems 7 via a conventional bus system, from which vehicle systems 7 ego-data which describe the condition of the motor vehicle 1, for example a direction of movement of the motor vehicle 1, the speed and the like can be obtained.

In order to obtain a very useful display for the driver, the location of the currently greatest criticality, i.e., the greatest risk for the motor vehicle is first analyzed. For this purpose, collision likelihoods with the objects can be determined, it is also conceivable however to make the selection of objects and with this the portion of the environment to be displayed and/or the direction of view to be displayed dependent on the direction of driving of the motor vehicle 1 and on the distances of the individual objects. For example the shortest distance to an object in driving direction of the motor vehicle 1 can always be observed, wherein the associated object defines the portion of the environment which is to be shown in the current image. The direction of view thus also results from situational criteria, wherein certain associations can be made for example in look-up tables. It is useful in most cases to select a side view, which means to select a direction of view during the process of rendering which essentially or entirely extends horizontally so that also the profile of the motor vehicle 1 can be recognized, for example in order to assess whether it is possible to drive underneath or above an object. Generally speaking it is preferred to select an essentially horizontal direction within a center plane between the motor vehicle and the object, wherein the center plane in particular extends vertically.

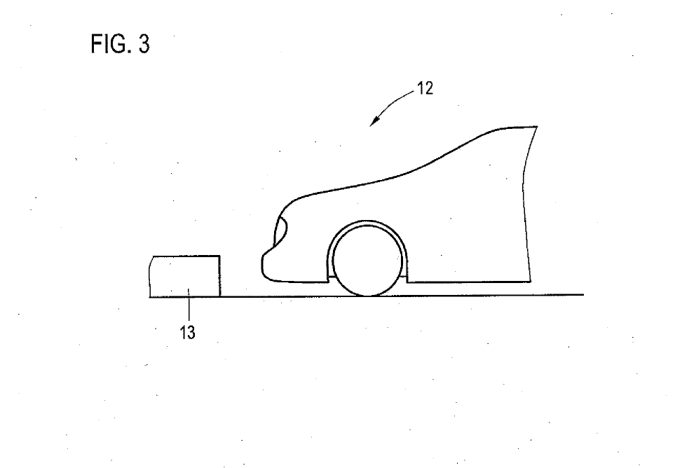

In the present case the driver assist system 2 generates different images, which are exemplary shown in FIGS. 2 and 3. FIG. 2 shows a generally present and available overview image 8, which depicts the motor vehicle from above. At the same time different objects 10 surrounding the motor vehicle 1 are shown corresponding to the three-dimensional environmental model.

The overview display 8 can also contain a display element 11, which indicates which view the current image 12 shown exemplary in FIG. 3 shows. Predominantly the direction of movement of the motor vehicle 1 and the short distance indicate that the interesting region for the driver of the motor vehicle 1 during maneuvering as object is a curb 13. Therefore the current display 12, here in a side view, i.e., along a horizontal direction of view, is generated by rendering from the three dimensional environmental model which also contains the motor vehicle 1 itself. With this the driver cannot only clearly recognize the distance of the motor vehicle 1 from the curb 13 but also the height of the curb 13 so that he obtains ideal information in order to move the motor vehicle 1 without causing damage.

It is noted that the current display 12 is always kept current based on the driving situation which means that when the driver engages the reverse gear the driving direction of the motor vehicle changes, i.e., the object behind the motor vehicle 1 in FIG. 2 may be more relevant so that a corresponding view is selected, preferably also a side view with essentially horizontal direction of view. As a result of the constantly maintained overview image 8, the overall view is always available for the driver.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for operating a driver assist system for supporting a driver during maneuvering and/or parking a motor vehicle, comprising:
recording with at least one environmental sensor three-dimensional environmental data of an environment of the motor vehicle;
generating with the driver assist system a three-dimensional model based on the three-dimensional data recorded by the environmental sensor, said model describing at least a portion of the motor vehicle and at least a portion of the environment of the motor vehicle;
generating with the driver assist system at least one image using the three-dimensional model, said image showing at least the at least one portion of the motor vehicle in relation to surrounding objects; and
displaying the image on a display.

2. The method of claim 1, wherein an optical image providing sensor is used as environmental sensor.

3. The method of claim 2, wherein the sensor is constructed as a PMD-sensor.

4. The method according of claim 1, wherein the at least one environmental sensor includes four wide-angle environmental sensors which are assigned respectively to one side of the motor vehicle.

5. The method of claim 1, further comprising assessing a risk of damage posed to the motor vehicle by the at least one portion of the environment of the motor vehicle and selecting the at least one portion of the environment of the motor vehicle to be shown in the image and/or a direction of view onto the portion of the environment as a function of the risk of damage to the vehicle posed by the at least one portion of the environment.

6. The method according to claim 5, further comprising determining for the objects a collision risk as a function of ego-data which describe a current operating condition of the motor vehicle, and using the collision risk for assessing the risk of damage posed to the motor vehicle by the portion of the environment of the motor vehicle.

7. The method of claim 5, wherein the portion selected to be shown in the image is a portion with a highest risk of damage to the motor vehicle relative to other portions of the environment of the motor vehicle.

8. The method of claim 5, wherein the assessing includes at least one of analyzing at least a shortest distance of the motor vehicle to one of the objects in the three dimensional environmental model and analyzing at least one current direction of movement of the motor vehicle.

9. The method according of claim 5, wherein the direction of view of the image onto the portion of the environment of the motor vehicle shown in the image extends along a line which lies in plane, said plane being defined in a region of a shortest distance to one of the objects,

10. The method according of claim 9, wherein the center plane is a vertical center plane.

11. The method of claim 10, wherein the direction of view lies in a range of +/−20° about the horizontal.

12. The method of claim 10, wherein the direction of view is a horizontal direction of view.

13. The method of claim 1, characterized in that the image is determined from the environmental model by rendering.

14. A motor vehicle comprising a driver assist system for supporting a driver during moving and/or parking with the motor vehicle, comprising:
at least one environmental sensor which records three-dimensional sensor data;
a display device; and
a control device configured
to generate a three-dimensional model based on the three-dimensional sensor data recorded by the environmental sensor, said model describing at least a portion of the motor vehicle and at least a portion of the environment of the motor vehicle;
to generate with the driver assist system at least one image using the three-dimensional model, said image showing at least the at least one portion of the motor vehicle in relation to surrounding objects; and
to display the image on a display.
